(19) United States
(12) Patent Application Publication
(10) Pub. No.: US 2009/0171837 A1
(43) Pub. Date: Jul. 2, 2009

(54) SYSTEMS AND METHODS FOR MOBILE PAYMENT

(76) Inventor: Joseph Leo Moreno, Carlsbad, CA (US)

Correspondence Address: FRANK G MORKUNAS, 7750 DAGGET ST, SUITE 203, SAN DIEGO, CA, 92111, US

(21) Appl. No.: 11/964,690

(22) Filed: Dec. 26, 2007

(51) Int. Cl. G06Q 20/00; H04Q 7/20

(52) U.S. Cl. 705/40

(57) ABSTRACT

Mobile payment methods and systems using Short Message System (SMS) messages include a card distribution point with a plurality of mobile payment cards, each card having an initially concealed card code, an initially concealed confirmation number, and a plurality of initially concealed Transfer Authorization Numbers (TANs), a payor device, a payee device, a merchant device, and a mobile payment system server. The server is configured to receive deposit SMS messages, determine whether a card code matches a card code associated with an active mobile payment card, and when a valid card code is received, increase an account balance associated with the payor device based on a value of the card, associate a plurality of TANs with the payor device based on TANs associated with the card, and send a reply SMS message including a confirmation number, transfers code for receiving a transfer SMS message from a payor device having a payee device identifier, a payment amount, and a TAN, determine whether the TAN included with the transfer SMS message is associated with the payor device, determine whether or not there are sufficient funds to cover the payment amount in the account associated with the payor device, and when a valid TAN is received and there are sufficient funds, update the account balance associated with the payor device and an account balance associated with the payee device, disassociate the TAN from the payor device, and generate an account balance SMS message for the payor device and the payee device.

### CROSS-REFERENCES TO RELATED PATENT APPLICATIONS

This application claims the benefit of U.S. provisional application Ser. No. 60/871,827, filed Dec. 24, 2006 which is incorporated herein by reference in its entirety for all purposes.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

1. Field

The claimed subject matter relates generally to systems and methods for mobile payments and, more particularly, to systems and methods for managing mobile payments using Transfer Authorization Numbers (TANs) to enable secure payments over a Short Message Service (SMS) network.

2. Description of the Related Art

SMS is a store-and-forward message delivery protocol that lets users send text messages to and from mobile phones and/or IP addresses including IP addresses associated with various types of systems and devices. Currently, cell phone and other SMS device users may transmit SMS messages (also known as text messages) of up to 1 60 characters (alphanumeric). GSM, TDMA and CDMA based mobile phone networks can support SMS. SMS users send a message by using a Common Short Code (CSC) or cell phone number which identifies a particular phone number or Internet Protocol (IP) address intended recipient. A Short Message Service Center (SMSC) will be responsible for transmitting the message to the appropriate recipient (e.g., IP address or phone).

By way of brief overview, an SMS system operates in the following manner for a mobile phone. The SMSC transmits an SMS Request to a Home Location Register (HLR) to find the mobile phone. The HLR will respond to the SMSC with the phone's status: 1) inactive or active 2) where the phone is roaming. If the response is ‘inactive’, then the SMSC holds the message for a predetermined period of time. When a subscriber accesses the recipient phone, the HLR sends a SMS Notification to the SMSC, and the SMSC will attempt delivery. The SMSC transfers the message to the system serving the mobile phone. The serving system pages the device and the message is delivered. The serving system notifies the SMSC that the message was received by the mobile device. The SMSC then categorizes the message as ‘sent’.

Because of the ease of use and ubiquity of SMS capable devices, for example primary mobile/cellular phones, the popularity of SMS communication is growing dramatically. A primary drawback of SMS communications, however, is that these communications are conventionally unencrypted. This means that communications may be read in the clear by a network operator's systems and personnel. Accordingly, present SMS communication systems are not appropriate for confidential communications, including conventional commercial transactions, such as money transfers.

By way of simple example, it is understood that commercial transactions may be implemented over a secure connection (e.g., Secure Hyper Text Transfer Protocol (HTTPS)) by encrypting a message from a sender to a receiver while the message is on the network. Accordingly, a user may send a confidential HTTPS message, such as a message including an account number, to a trusted vendor via a public network (e.g., the Internet) and, despite the fact that many unknown network systems may handle the message, the message is encrypted so that network systems and operators may not read the contents of the message and the account number is not subject to interception.

Attempting this same type of communication over an SMS network results in each network system that relays or otherwise accesses the SMS traffic being able to read the contents of the message, including the account number. If, for example, this account number may be used to transfer money from a first account to a second account, then a network operator may be able to read an SMS message and use the account number to inappropriately transfer additional funds from the first account to an account accessible by the network operator.

These and other drawbacks exist with current SMS systems and methods that prevent the adoption of SMS based mobile payment systems.

Accordingly, there exists a need for a mobile payment system that can address the aforementioned security issues.

### SUMMARY

The claimed subject matter relates generally to systems and methods for mobile payments and, more particularly, to systems and methods for managing mobile payments using Transfer Authorization Numbers (TANs) to enable secure payments over a Short Message Service (SMS) network.

According to one aspect of the claimed subject matter, systems of sending and receiving mobile payments using Short Message System (SMS) messages include a card distribution point with a plurality of mobile payment cards, each card having an initially concealed card code, an initially concealed confirmation number, and a plurality of initially concealed Transfer Authorization Numbers (TANs), a payor device, a payee device, a merchant device, and a mobile payment system server. The server is configured to receive deposit SMS messages, determine whether a card code matches a card code associated with an active mobile payment card, and when a valid card code is received, increase an account balance associated with the payor device based on a value of the card, associate a plurality of TANs with the payor device based on TANs associated with the card, and send a reply SMS message including a confirmation number, transfers code for receiving a transfer SMS message from a payor device having a payee device identifier, a payment amount, and a TAN, determine whether the TAN included with the transfer SMS message is associated with the payor device, determine whether or not there are sufficient funds to cover the payment amount in the account associated with the payor device, and when a valid TAN is received and there are sufficient funds, update the account balance associated with the payor device and an account balance associated with the payee device, disassociate the TAN from the payor device, and generate an account balance SMS message for the payor device and the payee device.

According to another aspect, systems of sending and receiving mobile payments using Short Message System (SMS) messages further include deposit confirmation executable code configured to initiate a telephone call to the payor device when the deposit SMS is received, receive a deposit Personal Identification Number (PIN) from the payor device in response to prompts provided during the telephone call, and associate the TANs associated with the deposit SMS only when the PIN matches a deposit PIN associated with the payor device.

According to another aspect of the claimed subject matter, a method for transferring funds using mobile payments includes the steps of purchasing a mobile payment card by a first merchant from a mobile payment system, the mobile payment card comprising an initially concealed card code, an initially concealed confirmation number, and a plurality of initially concealed TANs, purchasing the mobile payment card by a payor from the first merchant, conducting a mobile payment deposit from a payor device, conducting a mobile payment transfer from a payor device to a payee device; conducting a mobile payment withdrawal from the payee device to a second merchant device, and conducting a mobile payment withdrawal by a second merchant from the mobile payment system.

According to another aspect of the claimed subject matter, a method for transferring funds using mobile payments wherein the mobile payment deposit comprises receiving a deposit SMS message from the payor device, determining whether or not a card code included in the deposit SMS message matches a card code associated with one of the mobile payment cards, and when a valid card code is received, updating an account balance associated with the payor device, associating a plurality of TANs with the payor device, and sending a reply SMS message including a confirmation number.

According to another aspect of the claimed subject matter, a method for transferring funds using mobile payments wherein the mobile payment transfer includes the steps of receiving a transfer SMS message from a payor device, the transfer SMS message including a payee device identifier, a payment amount, and a TAN; determining whether the TAN included with the transfer SMS message is associated with the payor device; and when a valid TAN is received, updating the account balance associated with the payor device and an account balance associated with the payee device, disassociating the TAN from the payor device, and generating an account balance SMS message for the payor device and the payee device.

### BRIEF DESCRIPTION OF THE DRAWINGS

The accompanying drawings, which are incorporated in and constitute a part of this specification, illustrate several embodiments of the claimed subject matter, and together with the description, serve to explain the principles of the claimed subject matter. In the drawings,

FIG. 1A is a block diagram illustrating an exemplary embodiment of a system including a card distribution point for distributing cards having concealed TANs in accordance with the claimed subject matter;

FIG. 1B is a block diagram illustrating an alternate embodiment of a system including a merchant facsimile for just-in-time distribution of TANs in accordance with the claimed subject matter;

FIG. 2A is a flow diagram depicting a funds deposit in accordance with the system depicted in FIG. 1A;

FIG. 2B is a flow diagram depicting a funds deposit in accordance with the system depicted in FIG. 1B;

FIG. 3 is a flow diagram depicting a funds transfer involving SMS communications in accordance with the claimed subject matter; and

FIG. 4 is an exemplary flow diagram depicting a series of funds transfers in accordance with the claimed subject matter.

### DETAILED DESCRIPTION OF THE EMBODIMENTS

The described embodiments relate to systems and methods for managing mobile payments using Transfer Authorization Numbers (TANs) to enable secure payments over a Short Message Service (SMS) network. In the description, numerous specific details are set forth, such as transactions performed in the context of sending, securing and receiving activities in order to provide a thorough understanding of the various embodiments of the claimed subject matter. One skilled in the relevant art will recognize, however, that these embodiments can be practiced without one or more of the specific details, or with other methods or components.

Reference throughout this specification to “one embodiment” or “an embodiment” means that a particular feature, structure, or characteristic described in connection with the embodiment is included in at least one embodiment of the present claimed subject matter. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Additionally, embodiments of the claimed subject matter, such as those used with IP enabled devices, may be downloaded and used with a computer program product including a computer program product or products with instructions transferred from a remote computer such as a server over the internet. Computer enabled embodiments may also be used in any client/server environment implemented within multiple network architectures such as the World Wide Web.

a. Mobile Payment Systems

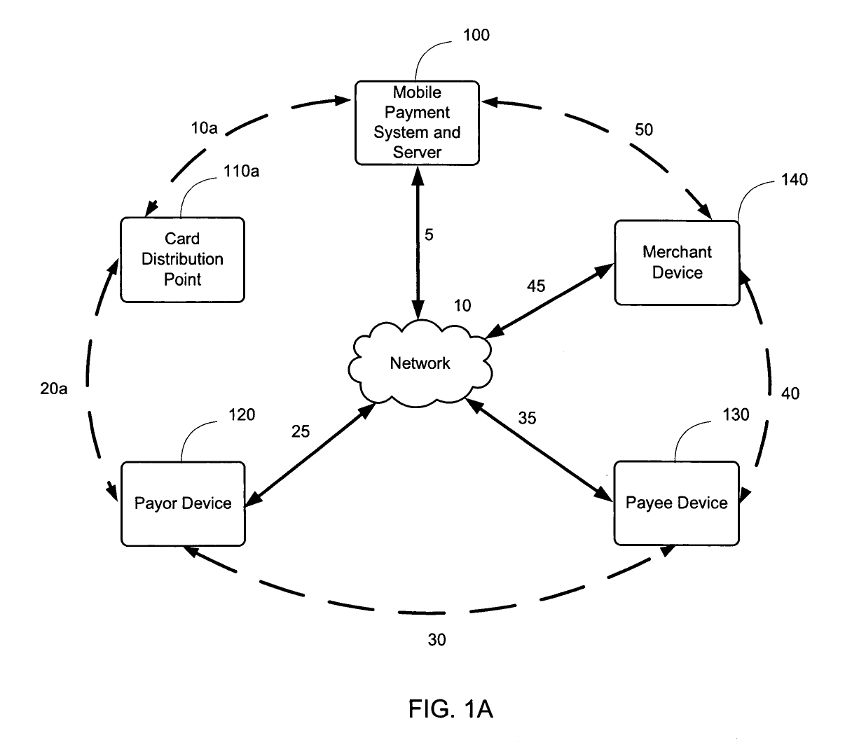

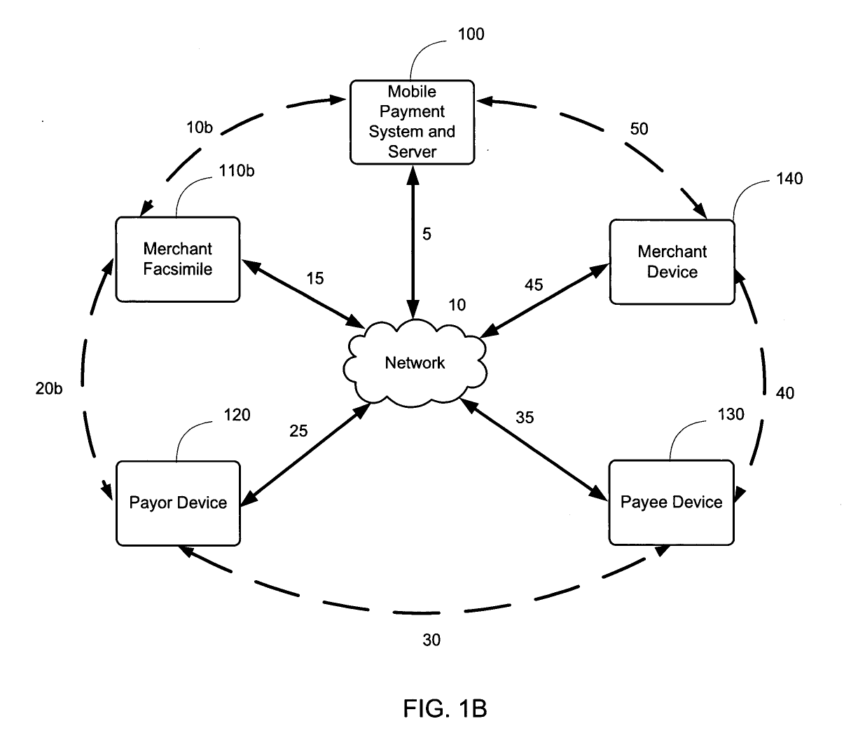

FIG. 1A is a block diagram illustrating an exemplary embodiment of a system in accordance with the claimed subject matter. Shown is a system for conducting mobile payments including mobile payment system and server 100, card distribution point 110a, payor device 120, payee device 130, merchant device 140, and network 10. Additionally, network connections 5, 25, 35, 45 (e.g., wide/local area network connections, cellular network connections, etc.) are shown which provide connectivity between devices 120, 130, 140, mobile payment system and server 100, and network 10. Furthermore, transaction pathways 10a, 20a, 30, 40, and 50 represent transactional relationships between elements 100, 110a, 120, 130, and 140 by which value (e.g., cash or cash equivalents and/or mobile money) may be transferred between entities using embodiments of the claimed subject matter. Each of these elements is described in greater detail below.

Card distribution point 110a may be a merchant that purchases a plurality of mobile payment cards, with a plurality being more than one card. Each of the mobile payment cards may include an initially concealed card code (which is unique in one preferred embodiment), an initially concealed confirmation number, and a plurality of initially concealed Transfer Authorization Numbers (TANs). In several of the embodiments, “initially concealed” is any technique that 1) initially prevents visual access to a set of concealed information and 2) substantially irreversibly changes the appearance of the card once a set of concealed information has been revealed. Substantially irreversibly means that the cost in terms of time, money, and/or effort of returning the appearance of the card to its initial state is greater than the fair market value of the card. One embodiment of the claimed subject matter uses “scratch-off” material, such that the card code, confirmation number, and each of the TANs is covered by scratch-off material that prevents visible access to the underlying information until the “scratch-off” material is removed.

Payor device 120, payee device 130, and merchant device 140 may be configured to send and receive one or more SMS messages. In one embodiment, payor device 120, payee device 130, and merchant device 140 are cellular phones with SMS capabilities, although other devices may be used. For example, merchant device 140 may be a computer having access to the World Wide Web via network 10.

Mobile payment system and server 100 may include a server (or a plurality of servers) having deposit executable source code and transfer executable source code. The deposit executable source code may be configured to receive a deposit SMS message from a payor device 120 and determine whether or not a card code matches a card code associated with an active mobile payment card. When a valid card code is received, the server may increase an account balance associated with the payor device 120 based on a face value (or any other determined value) of the active mobile payment card, associate a plurality of TANs with the payor device based on TANs associated with (e.g., printed on) the active mobile payment card, and send a reply SMS message including a confirmation number. Although one embodiment includes a reply SMS message, an alternate embodiment does not include a reply SMS message. Yet another embodiment includes a reply that is made by a communication channel or method other than SMS (e.g., a phone call).

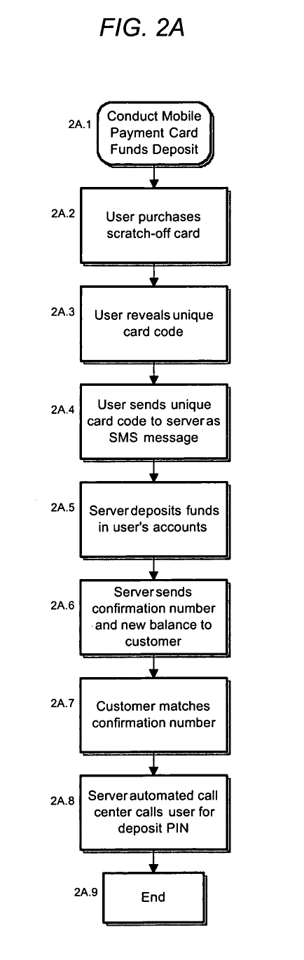

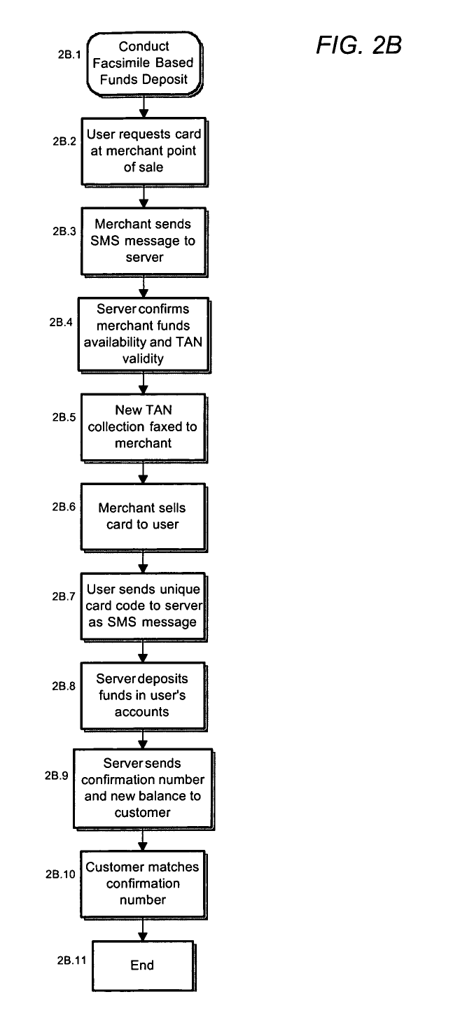

In one embodiment, deposit executable source code may additionally be configured to initiate a telephone call to the payor device when the deposit SMS is received, receive a deposit Personal Identification Number (PIN) from the payor device in response to prompts provided during the telephone call, and associate the TANs associated with the active mobile payment card only when the PIN matches a deposit PIN associated with the payor device 130. In this way, if a device is lost or stolen, an unauthorized user is prevented from gaining access to the funds stored on the lost or stolen device because the unauthorized user would not be able to associate the TANs with the device without the deposit PIN. It is understood that a single-use TAN (each TAN may be used only once) is suitable for communication on a non-encrypted, multi-party readable channel (e.g., SMS message) whereas the PIN, which may be used for multiple deposits, may be unsuitable for SMS communication and should be transmitted by other means (telephone call, HTTPS, etc.). Deposit executable source code functionality is described in greater detail with respect to FIGS. 2A and 2B.

The deposit executable source code (and additional described executable source code) may be source code written in programming languages (e.g., such as Java, C++, C#, etc.) and/or scripting languages (e.g., PHP: Hypertext Preprocessor, Active Server Pages, Visual Basic, etc.) and may interact with data structures and data scripts associated with one or more databases (e.g., Oracle, MySQL, SQL Server, Access, etc.). Accordingly, executable source code may be one or more physical files and one or more associated data stores residing on one or more servers that, in coordination with server resources such as a processor, memory, and complimentary applications and frameworks (e.g., an Apache web server for PHP, the .NET Framework for C# pages, etc.), implement the described functionality.

Mobile payment system and server 100 may additionally include transfer executable source code configured to receive a transfer SMS message from a payor device 120. The transfer SMS message including a payee device identifier (e.g., a phone number associated with payee device 130), a payment amount, and a TAN. The transfer executable source code additionally may be configured to determine whether the TAN included with the transfer SMS message is associated with the payor device (e.g., whether the TAN is associated with an account associated with the payor device). For example, the mobile payment server may receive a message via network connection 5 that includes a TAN, a payee device identifier (e.g., payee phone number), a transfer amount (e.g., $50), and a transmitting device identifier (e.g., the phone number of the payor device 120). The transmitting device identifier may be transmitted as part of the message payload, as part of the header data associated with the message, a combination of the two, or by other means. The mobile payment server may perform a lookup in a data store to determine whether the received TAN is presently associated (i.e., whether the TAN is valid) with the payor device account.

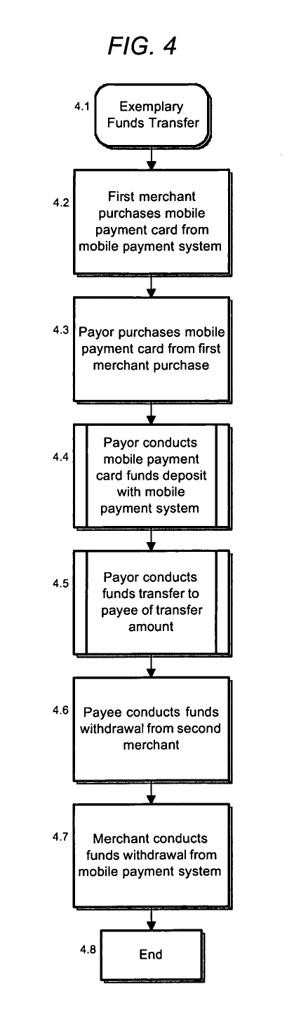

When a valid TAN is received, the mobile payment server may update the account balance associated with the payor device and an account balance associated with the payee device. Additionally, to prevent replay attacks, the mobile payment server may disassociate the TAN from the payor device, such that a subsequent transfer SMS message having the same TAN would no longer result in a transfer of funds even if the payor's account had sufficient funds. An exemplary scenario of mobile payment transfers through the system depicted in FIG. 1A is provided with respect to FIG. 4 below.

Turning to FIG. 1B, shown is an alternative embodiment of the claimed subject matter in which corresponding elements are provided with the same reference numbers. This embodiment differs from the embodiment of FIG. 1A because a merchant facsimile 110b is used instead of a card distribution center 110a. In one embodiment, a merchant may send a fax-back SMS message to a mobile payment system phone number or common short code. This fax-back SMS may include an instruction that this is a fax-back transaction (as opposed to a transfer, deposit, etc.), a phone number to which the mobile payment card is to be faxed, a face value of the mobile payment card, and a TAN, as described in greater detail below with respect to FIG. 2B. If the merchant has sufficient funds in the merchant account to cover the face value of the mobile payment card (plus any fees) and the TAN is a valid TAN for the merchant, the mobile payment system will fax a page to the phone number provided in the fax-back SMS message, and this fax will include a plurality of TANs that may be used in a manner similar to the TANs described above (with one difference being that the TANs will be initially visible on the fax).

Use of merchant facsimile 110b enables a merchant to purchase mobile money from the mobile payment system in a just-in-time manner. Specifically, when the system involves a card distribution center, a merchant must purchase a card and carry the price of the corresponding mobile money (plus any transaction fees that may cause the purchase price of the cards to exceed the face value of the cards), while a merchant may wait until a customer has purchased a mobile payment card prior to incurring any expense when a fax-back system is used.

In addition to the card distribution center 110a depicted in FIG. 1A and the merchant facsimile 110b depicted in FIG. 1B, other methods of distributing TANs may be implemented, such as a secure website by which a merchant may provide a merchant account number, a face value, and a TAN, and print out a response page that includes a plurality of TANs (assuming the TAN is valid for the merchant account and the merchant account has sufficient funds).

b. Mobile Payment Methods

FIG. 2A is a flow diagram depicting a funds deposit in accordance with the system depicted in FIG. 1A. The method includes purchasing a mobile payment card (e.g., from a merchant/card distribution point) at 2A.2. This mobile payment card has an initially concealed card code, an initially concealed confirmation number, and a plurality of initially concealed TANs, such as a scratch-off card. The user may then reveal the card code at 2A.3 by, for example, scratching off the material initially concealing the card code. The user may then send this card code as part of an SMS message (e.g., an exemplary message format of “Deposit 4497-8744-5721” where the word “Deposit” is the instruction and “4497-8744-572 1” is the card code, with the phone number of the depositing account serving as the unique identifier for the account into which the funds will be deposited).

If the received card code is valid (e.g., has been issued and has not yet been deposited into an account or otherwise rendered invalid), the mobile payment server may deposit funds equivalent to the face value of the mobile payment card into user's account. Additionally, the TANs associated with the mobile payment card may be associated with the user's account, thereby enabling these TANs to be used in future mobile money transfers. Additionally, the mobile payment server may then invalidate the card code to prevent subsequent deposits using the same card code.

The remainder of the steps (2A.6 to 2A.8) may be eliminated in other embodiments of the claimed subject matter, and the mobile payment cards may be modified such that they do not include a confirmation number. Alternatively, 2A.6 may be modified such that the server sends a new account balance, and not a confirmation number, to the user's device or any other predetermined device. However, in the present embodiment, once a deposit is made at 2A.5, the server sends a confirmation number and a new account balance to the customer 2A.6. The customer may then match this confirmation number to the initially concealed confirmation number to ensure that the card is valid 2A.7. If the confirmation numbers do not match, the customer may substantially immediately (e.g., within the amount of time that it takes to generate an SMS message, receive a response, and conduct the confirmation number comparison) request a refund.

In an embodiment, the mobile payment system may initiate a phone call (automated or otherwise) for a deposit PIN 2A.8. If this is the first deposit into an account, the mobile payment system may request that the user selects a deposit PIN. If this is a subsequent deposit (e.g., an account already exists for the customer), the mobile payment system may prompt the user for the deposit PIN and effectuate the deposit only when the appropriate deposit PIN is provided. Deposit PINs may be useful in preventing a lost or stolen phone associated with an account having mobile money in it from being compromised by an unauthorized user (e.g., where the unauthorized user deposits additional mobile money into an account and gains access to all the funds of the account with the newly associated TANs).

FIG. 2B is a flow diagram depicting a funds deposit in accordance with the system depicted in FIG. 1B, an illustration of a fax-back system embodiment. At 2B.2, the user requests a mobile payment card at a merchant point of sale. The merchant sends an SMS message to the mobile payment server 2B.3 that includes fax-back information, face value of the purchased card, and a TAN associated with the merchant's mobile money account. For example, the SMS message may have the following exemplary format: “FaxCard 2125551212 50 1 9689” (where “FaxCard” is the instruction, “2125551212” is the phone number to which the mobile payment card will be faxed, “50” is the face value of the card to be purchased, and “1 9689” is the TAN provided for this transaction.)

In this embodiment, the mobile payment server confirms the merchant has sufficient funds to cover the face value of the mobile payment card as well as any related costs or fees and additionally confirms that the received TAN is valid for the merchant account 2B.4. If funds are available and the TAN is valid, a fax is sent to the provided fax-back number. This fax will include a plurality of TANs, a card code, and a confirmation number 2B.5. The user may then deposit these funds into a mobile payment account as described above with respect to 2A.4-2A.7.

Additionally, as with the distributed mobile payment cards method, the fax-back deposit method may include a phone call (automated or otherwise) initiated by the mobile payment server for a deposit PIN (not shown in FIG. 2B). If this is the first deposit into an account, the mobile payment system may request that the user selects a deposit PIN. If this is a subsequent deposit (e.g., an account already exists for the customer), the mobile payment system may prompt the user for the deposit PIN and effectuate the deposit only when the appropriate deposit PIN is provided.

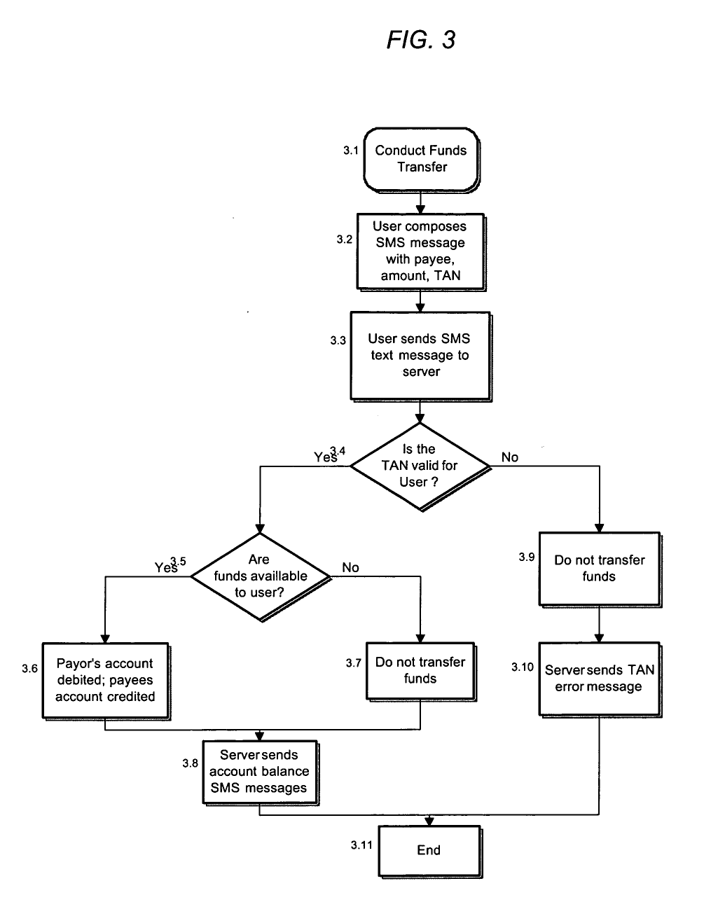

FIG. 3 is a flow diagram depicting a mobile funds transfer involving SMS communications in accordance with embodiments of the claimed subject matter. A user composes an SMS message with payee, amount, and TAN at 3.2. For example, a user may compose the following message: “2125553434 9.95 87143” (where “21 25553434” is the phone number of the payee and also a unique identifier for the payee's account, “9.95” is the amount of mobile money to transfer, and “871 43” is the TAN provided for this transaction that is associated with the user's account as described above). The user may then send the composed message to a phone number or common short code associated with the mobile payment system at 3.3.

In several embodiments, the mobile payment server may determine whether the TAN is valid for the account associated with the sending device's phone number at 3.4. If the message is not valid (e.g., the TAN has never been associated with the user's account or the TAN was used after being associated with the user's account), the server may deny the transfer 3.9 and send a message to the sending device (e.g., to the user) indicating that there was a problem with the received TAN 3.10.

In these embodiments, if the TAN is valid, the server then determines whether there are sufficient funds available to cover the amount of the transfer (as indicated in the composed transfer SMS message plus any fees) at 3.5. If there are funds available, the server debits the payor's account and credits the payee's account at 3.6. If the system is implemented such that transfer fees are charged, transfer fees may be applied to the payor's account (e.g., a transfer of $9.95 causes a deduction of $10.00 from the payor's account), may be applied to the payees account (e.g., if the payor sends a transfer SMS message indicating a $9.95 transfer amount, the payee receives $9.90), may be applied to a combination of the two, or may be collected by other methods. If funds are not available at 3.5, no funds are transferred 3.7.

The server may then send appropriate account balance SMS messages to the payor and/or the payee 3.8. For example, if funds were available, the server may send updated account balances to the payor and payee. If funds were not available, the server may send current account balances to the payor and the payee, or just the payee, depending on the objectives of a system implementer.

It is understood that modifications may be made to the aforementioned method without departure from the spirit or the scope of the claimed subject matter. For example, funds availability may be determined before TAN validity is determined, additional or fewer SMS messages may be sent by the server, and other modifications may be made based on the needs of the system.

FIG. 4 is an exemplary, overview flow diagram depicting a series of funds deposits and transfers in accordance with embodiments of the claimed subject matter. A card distribution point, such as a merchant, may conduct a transaction or series of transactions (referred to as transaction for this overview) via mobile payment system to card distribution point transaction pathway 10a at 4.2. This transaction may involve the purchase of a number of mobile payment cards having, for example, a $100 face value for $101 each. A payor (owner of payor device 120) may conduct a transaction with the card distribution point 110a via card distribution point to payor device transaction pathway 20a. In several embodiments, this transaction may involve purchasing one of the $100 face value mobile payment cards from the card distribution point for $105 at 4.3 and then adding this value to an account associated with payor device 120 at 4.4 (e.g. utilizing a method as described in relation to FIG. 2A above). Once value (i.e. refills in the form one or more monetary amounts) is added to an account, it may be referred to as mobile money.

Payor device 120 may be used to transfer some or all of the mobile money from the account associated with payor device 120 to an account associated with payee device via payor device to payee device transaction pathway 30 at 4.5, as described in greater detail with respect to FIG. 3 above. For example, payor device 120 may be used to transfer $50 of mobile money from the account associated with payor device 120 to the account associated with payee device 130. In one embodiment, a fee may be charged by the mobile payment system (e.g., a per-transaction fee and/or percentage fee deducted from the payor's account and/or the payee's account) for transfers. In one embodiment, payor device and payee device are physically remote, and transferring cash or other physical assets directly between users associated with these devices is not commercially feasible (e.g., the transaction costs and/or transportation risks of transferring physical assets between the parties make the direct exchange unfeasible). Furthermore, in other embodiments, transaction pathway 30 is not possible through a banking or other conventional financial institution intermediary because the payor, the payee, or both do not have an account with a conventional financial institution, such as a bank.

Payee device 130 may then be used by the payee to withdraw funds from a mobile account at 4.6. For example, payee device may be used to withdraw funds from the payee's account by transferring the funds in the form of mobile money from the payee account to an account associated with merchant device 140 via payee device to merchant device transaction pathway 40. In one embodiment, this may involve payee device sending a transfer SMS message to the mobile payment server, as described in relation to FIG. 3, and the merchant associated with merchant device 140 providing cash in exchange for the received mobile money. For example, if payee device is used to transfer $50 of mobile money from the payee device account to the merchant device account, the merchant may pay the payee $49. Similarly, the payee may be charged a fee to collect the face value of the mobile payment (e.g., pay $1 to collect the $50). Additionally, the mobile payment system may assess a transaction fee on the payee, the merchant, both, or neither for transferring mobile payments between the parties.

The merchant may withdraw cash from the embodiments of the system via merchant device to mobile payment system and server transaction pathway 50 at 4.7. For example, merchant device 140 may be used to transfer the mobile money in the merchant's account back to the system, for which the merchant receives cash. The merchant may receive the cash by a variety of methods, such as physical delivery of the cash to the merchant by an agent of the mobile payment system, by an automated system that transfers funds into a bank account associated with the merchant upon receipt of mobile money, or by any other suitable method and/or system. In the described embodiments, transferring mobile money from the merchant's account to the mobile payment system may result in a transaction fee, no transaction fee, or a transaction fee under certain conditions (e.g., transfers of $1,000 or more have no fee.)

Additionally, mobile payment system embodiments may include a data store and related executable code for preventing certain people and/or numbers from creating accounts. These blocked numbers may be individual numbers (e.g., a number used previously in a fraudulent transaction), a set of numbers (e.g., a set of numbers in a particular area code or assigned by a particular service provider), or based on other criteria.

It is noted that the exemplary transfer message does not include an instruction (e.g., the initial text for a fax-back transaction was the instruction “FaxCard”). In one embodiment, the default or implied instruction is “Transfer,” so that a user does not need to include the “Transfer” instruction. In another embodiment, the server may determine the instruction based on the format of the received SMS message. For example, the mobile payment server may use spaces as data separators and determine the type of message that is being received based on the signature of the message, so that if the first data item received is an instruction, the server handles the SMS message in accordance with the method associated with the instruction; if the first data item is a phone number, the server handles the SMS message in accordance with a default method (e.g., treats the SMS message as a transfer request); and if the first data item is a card code, the server handles the SMS message as a deposit request.

In one embodiment, the mobile payment server may provide executable source code to accept data in a variety of text formats and convert this data into the same format. For example, the mobile payment server may convert each of the following received data items into the same data item based on predetermined rules: (212)555-1212, 212-555-1212, and 2125551212. In one embodiment, a space is a special character that signifies the separation of data items.

The foregoing description of the embodiments of the claimed subject matter are provided for illustration and description and are not intended to be exhaustive or to limit the claimed subject matter to the precise form disclosed. Modifications and variations are possible in light of the above teachings or may be acquired from practice of the claimed subject matter. For example, while series of acts have been described with regard to FIGS. 2A-4, the order of the acts may be modified in other implementations consistent with principles of the claimed subject matter. Further, non-dependent acts may be performed in parallel. Additionally, other implementations consistent with principles of the claimed subject matter may be used including various user interfaces that include more, fewer, or different pieces of information.

It will be apparent to one of ordinary skill in the art that aspects of the claimed subject matter, as described above, may be implemented in many different forms of software, firmware, and hardware in the implementations illustrated in the figures. The actual software code or specialized control hardware used to implement aspects consistent with principles of the claimed subject matter is not limiting of the claimed subject matter. Thus, the operation and behavior of the aspects were described without reference to the specific software code—it being understood that one of ordinary skill in the art would be able to design software and control hardware to implement the aspects based on the description herein.

No element, act, or instruction used in the present application should be construed as critical or essential to the claimed subject matter unless it has been explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A system for conducting mobile payments comprising:
a card distribution point comprising a plurality of mobile payment cards, the mobile payment cards having an initially concealed card code, an initially concealed confirmation number, and a plurality of initially concealed Transfer Authorization Numbers (TANs);
a payor device configured to send and receive Short Message System (SMS) messages;
a payee device configured to send and receive SMS messages;
a merchant device configured to send and receive SMS messages; and
a mobile payment system server comprising deposit executable source code configured to:
receive a deposit SMS message from a payor device;
determine whether a card code matches a card code associated with an active mobile payment card; and
when a valid card code is received, increase an account balance associated with the payor device based on a face value of the active mobile payment card, associate a plurality of TANs with the payor device based on TANs associated with the active mobile payment card, and send a reply SMS message including a confirmation number; and
transfer executable source code configured to:
receive a transfer SMS message from a payor device, the transfer SMS message including a payee device identifier, a payment amount, and a TAN;
determine whether the TAN included with the transfer SMS message is associated with the payor device;
determine whether or not there are sufficient funds to cover the payment amount in the account associated with the payor device;
when a valid TAN is received and there are sufficient funds, update the account balance associated with the payor device and an account balance associated with the payee device, disassociate the TAN from the payor device, and generate an account balance SMS message for the payor device and the payee device.

2. The system of claim 1, further comprising deposit confirmation executable code configured to:
initiate a telephone call to the payor device when the deposit SMS is received;
receive a deposit Personal Identification Number (PIN) from the payor device in response to prompts provided during the telephone call; and
associate the TANs associated with the deposit SMS only when the PIN matches a deposit PIN associated with the payor device.

3. A method for transferring funds using mobile payments comprising:
purchasing a mobile payment card by a first merchant from a mobile payment system, said mobile payment card comprising an initially concealed card code, an initially concealed confirmation number, and a plurality of initially concealed TANs;
purchasing the mobile payment card by a payor from the first merchant, conducting a mobile payment deposit from a payor device;
conducting a mobile payment transfer from a payor device to a payee device;
conducting a mobile payment withdrawal from the payee device to a second merchant device; and
conducting a mobile payment withdrawal by a second merchant from the mobile payment system.

4. The method of claim 3, wherein the mobile payment deposit comprises:
receiving a deposit SMS message from the payor device;
determining whether a card code included in the deposit SMS message matches a card code associated with one of the mobile payment cards; and
when a valid card code is received, updating an account balance associated with the payor device, associating a plurality of TANs with the payor device, and sending a reply SMS message including a confirmation number.

5. The method of claim 3, wherein the mobile payment transfer comprises:
receiving a transfer SMS message from a payor device, the transfer SMS message including a payee device identifier, a payment amount, and a TAN;
determining whether or not the TAN included with the transfer SMS message is associated with the payor device; and
when a valid TAN is received, updating the account balance associated with the payor device and an account balance associated with the payee device, disassociating the TAN from the payor device, and generating an account balance SMS message for the payor device and the payee device.
